(19) United States
(12) Patent Application Publication
(10) Pub. No.: US 2008/0183859 A1
(43) Pub. Date: Jul. 31, 2008

(54) Methods, systems, and products for promoting programs

(76) Inventor: Jeffrey A. Aaron, Atlanta, GA (US)

Correspondence Address: SCOTT P. ZIMMERMAN, PLLC, PO BOX 3822, CARY, NC, 27519, US

(21) Appl. No.: 11/700,622

(22) Filed: Jan. 31, 2007

(51) Int. Cl. G06F 15/173; G06F 17/30

(52) U.S. Cl. 709/224; 707/3

(57) ABSTRACT

Methods, systems, and products are disclosed for conducting a location-based promotional program. Location information for a device is received. A database of promotional locations is queried for the location information. The database of promotional locations stores locations that qualify for entry in the promotional program. When the location information matches a location in the database of promotional locations, then a user of the device, and/or the device, is entered in the promotional program.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The exemplary embodiments generally relate to data processing and to communications and, more particularly, to incentive or promotion programs and to location monitoring.

Location monitoring may be used to attract customers. Wireless phones, personal data assistants, and other devices may have location capabilities. That is, these devices are able to report their current location. If merchants utilize these location capabilities, merchants could entice customers to visit. When customers experience the merchant's goods and services, customers are more apt to spend money. What is needed, then, are methods, systems, and products that enable and conduct location-based promotional programs.

### SUMMARY

The exemplary embodiments provide methods, systems, and products for conducting location-based promotional programs. Exemplary embodiments utilize location coordinates to automatically enter a user in a promotional program. The promotional program may be any game, sweepstakes, drawing, or activity offering an incentive for users to visit merchant establishments. When a user's current location matches a location of a participating merchant's store, exemplary embodiments automatically enter that user in the promotional program. The user may then advance within the promotional program to win more/better prizes. The user's location may even be used to cross-promote goods and services from different merchants.

Exemplary embodiments include a method for conducting a location-based promotional program. Location information for a device is received. A database of promotional locations is queried for the location information. The database of promotional locations stores locations that qualify for entry in the promotional program. When the location information matches a location in the database of promotional locations, then a user of the device, and/or the device, is entered in the promotional program.

More exemplary embodiments include a system for conducting a location-based promotional program. Location information for a device is received. A database of promotional locations is queried for the location information. The database of promotional locations stores locations that qualify for entry in the promotional program. When the location information matches a location in the database of promotional locations, then a user of the device, and/or the device, is entered in the promotional program.

Other exemplary embodiments describe a computer program product for conducting a location-based promotional program. The computer program product stores instructions for receiving location information for a device. A database of promotional locations is queried for the location information. The database of promotional locations stores locations that qualify for entry in the promotional program. When the location information matches a location in the database of promotional locations, then a user of the device, and/or the device, is entered in the promotional program.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a schematic illustrating an environment in which exemplary embodiments may be implemented;

FIGS. 2 and 3 are schematics illustrating a process for automatic entry, according to more exemplary embodiments;

FIG. 4 is a schematic illustrating another process for promotional programs, according to more exemplary embodiments;

FIG. 5 is a schematic illustrating another process for promotional programs, according to more exemplary embodiments;

FIG. 6 is a schematic illustrating yet another process for promotional programs, according to more exemplary embodiments;

FIG. 7 depicts other possible operating environments for additional aspects of the exemplary embodiments; and

FIG. 8 is a flowchart illustrating a method of promoting a program, according to even more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

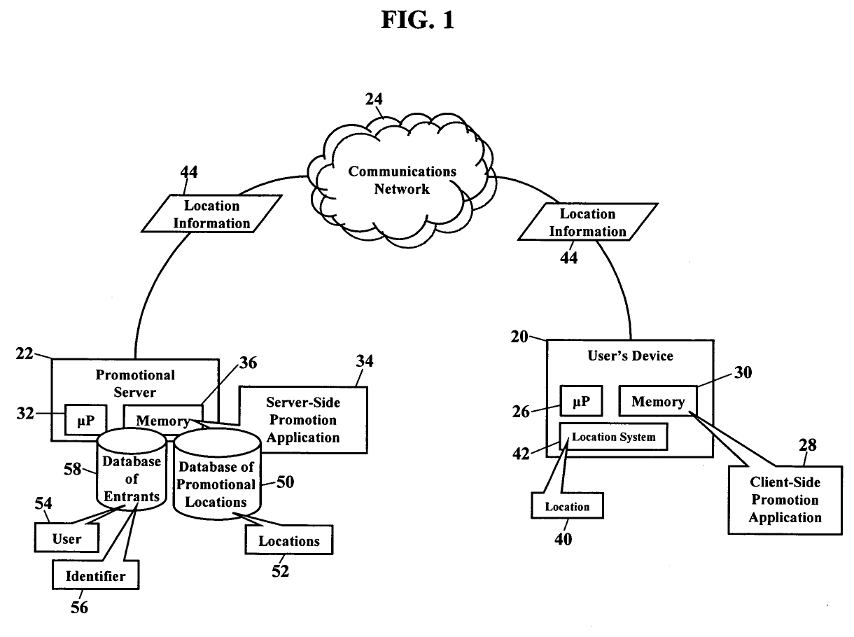

FIG. 1 is a schematic illustrating an environment in which exemplary embodiments may be implemented. A user's device 20 communicates with a promotional server 22 via a communications network 24. Although the user's device 20 is generically shown, the device 20, as will be later explained, may be a computer, a radio, a personal digital assistant (PDA), a cordless/cellular/IP phone, digital music player, or any other processor-controlled device. Whatever the user's device 20, the user's device 20 has a processor 26 (e.g., “μP”), application specific integrated circuit (ASIC), or other similar device that executes a client-side promotion application 28 stored in memory 30. The promotional server 22 includes a processor 32 that executes a complementary server-side promotion application 34 stored in memory 36. According to exemplary embodiments, the client-side promotion application 28 and the complementary server-side promotion application 34 are processor-executable instructions that cooperate to provide a location-based promotional program. That is, some merchant's products or services are promoted based on a location 40 of the user's device 20. As the user carries the device 20, a location system 42 determines or monitors the current location 40 of the user's device 20. The location system 42 may utilize any technique for obtaining the current location of the user's device 20, such as triangulation and/or global positioning system information. The location system 42 communicates location information 44 to the promotional server 22, and the location information 44 describes the current location 40 associated with the user's device 20. While the location system 42 is shown residing or operating in the user's device 20, the location system 42 may optionally operate within the promotional server 22. Moreover, the location system 42 may alternatively or additionally be a service provided by a separate server and accessible via the communications network 24. Because, however, location systems are well known to those of ordinary skill in the art, no further discussion is made.

The user may be automatically entered into a promotional program. When the promotional server 22 receives the location information 44, the server-side promotion application 34 may query a database 50 of promotional locations. The database 50 of promotional locations is illustrated as being locally stored in the memory 36 of the promotional server 22, yet the database 50 of promotional locations may be remotely accessible via the communications network 24. According to exemplary embodiments, the database 50 of promotional locations stores locations 52 that qualify for entry in one or more of the promotional programs. The server-side promotion application 34 queries the database 50 of promotional locations to determine if the location information 44 matches one or more of the locations 52 in the database 50. If the location information 44 associated with the user's device 20 matches one or more of the locations 52, then the server-side promotion application 34 may automatically enter or enroll the device 20 in the promotional program. If the location information 44 does not match a location 52 in the database 50 of promotional locations, then the server-side promotion application 34 may or may not enter the device 20 in the promotional program.

The user may be added as an entrant or full/partial participant to the promotional program. Whenever the current location 40 of the user's device 20 matches some entry in the database 50 of promotional locations, then the server-side promotion application 34 may add the user as a user 54 and/or add an identifier 56 of the user's device 20 to a database 58 of entrants. The database 58 of entrants stores information that describes all the devices, and/or all the users, that have been entered into the promotional program. The database 58 of entrants is illustrated as being locally stored in the memory 36 of the promotional server 22, yet the database 58 of entrants may be remotely accessible via the communications network 24. The user 54 may be identified by a name, address, username, password, or other identifier that uniquely identifies the user. Combinations of these or any identifiers, along with other associated information such as affiliation and/or employer, may also be used. Similarly, the identifier 56 of the user's device 20 may be a serial number, MAC address, IP address, IM (Instant Messaging) “handle,” communications address, telephone number, or other identifier that uniquely identifies the user's device 20. When the user carries the device 20 to any of the locations 52 in the database 50 of promotional locations, then the user (or the user's device 20) may be entered in the promotional program.

The user thus may be automatically entered in the promotional program. When a merchant wishes to attract customers, the merchant adds its physical location(s) 52 to the database 50 of promotional locations. When the user's device 20 matches one or any of the merchants' predetermined physical locations 52, then the server-side promotion application 34 automatically adds the user (and/or the user's device 20) to the merchant's promotional program. The user is thus automatically entered in the merchant's promotional program, for example, simply by entering the merchant's physical location and/or proximity. According to further embodiments, the user of the user's device 20 may be provided with an option to join the promotional program via, for example, a message provided by the server-side promotion application 34 to the user's device, instead of being automatically entered into the promotional program. Whatever the incentive (cash and/or prizes), exemplary embodiments automatically enroll the user based on location.

Exemplary embodiments may be applied regardless of networking environment. The communications network 24 may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

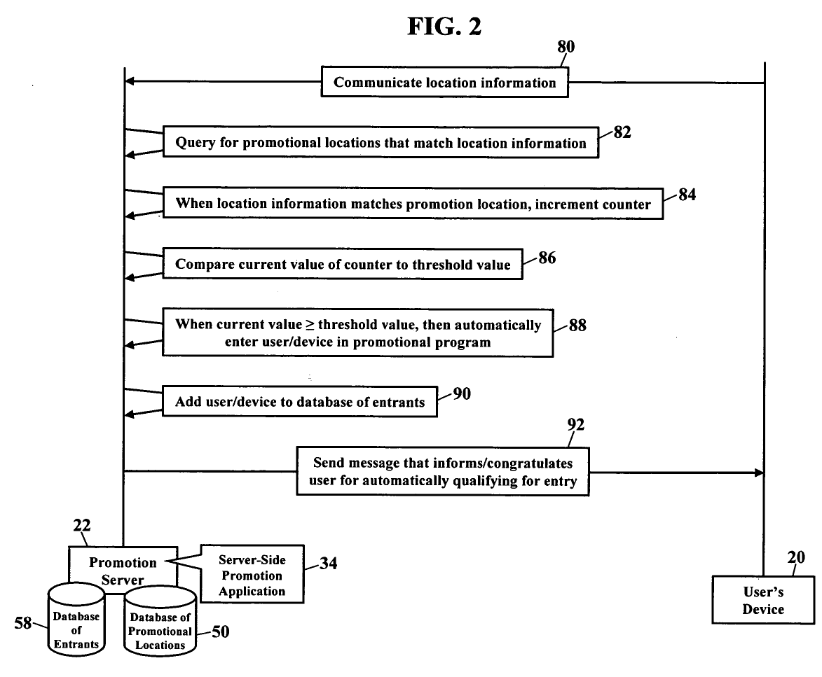

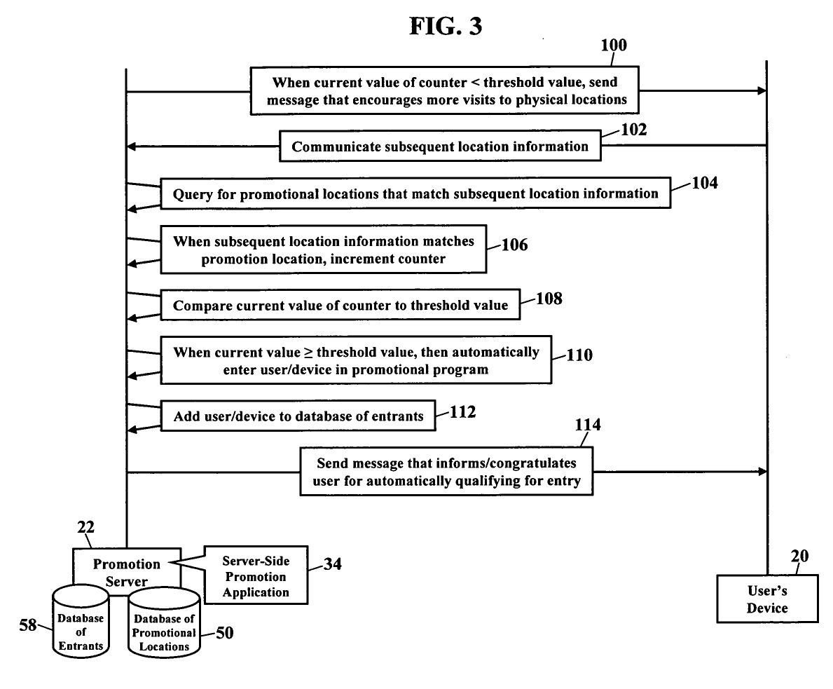

FIGS. 2 and 3 are schematics illustrating a process for automatic entry, according to more exemplary embodiments. Here, when multiple merchant's (or merchants') physical locations are visited, the user and/or the user's device 20 is automatically entered into a promotional program. As the user carries the device 20, the location system 42 communicates the location information to the promotional server 22 (Step 80). When the promotional server 22 receives the location information, the server-side promotion application 34 queries the database 50 of promotional locations (Step 82). When the location information matches a location in the database 50, then the server-side promotion application 34 increments a counter (Step 84). The counter tallies or tabulates the number of location matches for the user's device 20. The server-side promotion application 34 then compares a current value of the counter to a threshold value (Step 86). When the current value of the counter is greater than (or equal to) the threshold value, then the server-side promotion application 34 may automatically enter or enroll the device 20 in the promotional program or provide the user of the device 20 with the option to enter or enroll in the promotional program (Step 88). The server-side promotion application 34 adds the user, and/or the identifier of the user's device 20, to the database 58 of entrants (Step 90). The server-side promotion application 34 may also send a message to the user's device 20 (Step 92), and the message may congratulate the user for automatically qualifying for entry in the promotional program.

The process continues with FIG. 3. When the current value of the counter is less than the threshold value, then the server-side promotion application 34 may send a message to the user's device 20 (Step 100). The message may indicate that the user has not (yet) qualified for automatic entry in the promotional program, and the message may encourage the user to visit more merchant's (or merchants') physical locations. As the user again carries the device 20, the location system (shown as reference numeral 42 in FIG. 1) communicates subsequent location information to the promotional server 22 (Step 102). When the promotional server 22 receives the subsequent location information, the server-side promotion application 34 again queries the database 50 of promotional locations (Step 104). When the subsequent location information 44 matches a location in the database 50, then the server-side promotion application 34 again increments the counter (Step 106). The server-side promotion application 34 compares the current value of the counter to the threshold value (Step 108). When the current value of the counter is greater than (or equal to) the threshold value, then the server-side promotion application 34 may automatically enter the device 20 in the promotional program (Step 110) by adding the user, and/or the identifier of the user's device 20, to the database 58 of entrants (Step 112) or provide the user of the device 20 with the option to enter in the promotional program. The server-side promotion application 34 may also send the message (Step 114) that congratulates the user.

FIGS. 2 and 3 illustrate how multiple locations may be required for automatic entry in the promotional program. STARBUCKS®, for example, may require that the user make multiple visits to retail locations before the user is automatically entered into the promotional program. Whatever the promotional program, STARBUCKS® may require that the user visit a single physical location, or multiple physical locations, before automatic entry is attained. Other promotional programs may require visits to different merchant's physical locations. STARBUCKS® and SEARS®, for example, may partner and cross-promote or sponsor a promotion where the user must visit a STARBUCKS® retail location and a SEARS® retail location before automatic entry is attained. The promotional program may additionally require a purchase to qualify for automatic entry. Additionally, the promotional program may be time-limited and/or the terms of the program may change over time. Combinations of purchases, number of visits, visits to particular locations among the qualifying locations, visits and/or purchases within certain time periods, and other conditions may be required.

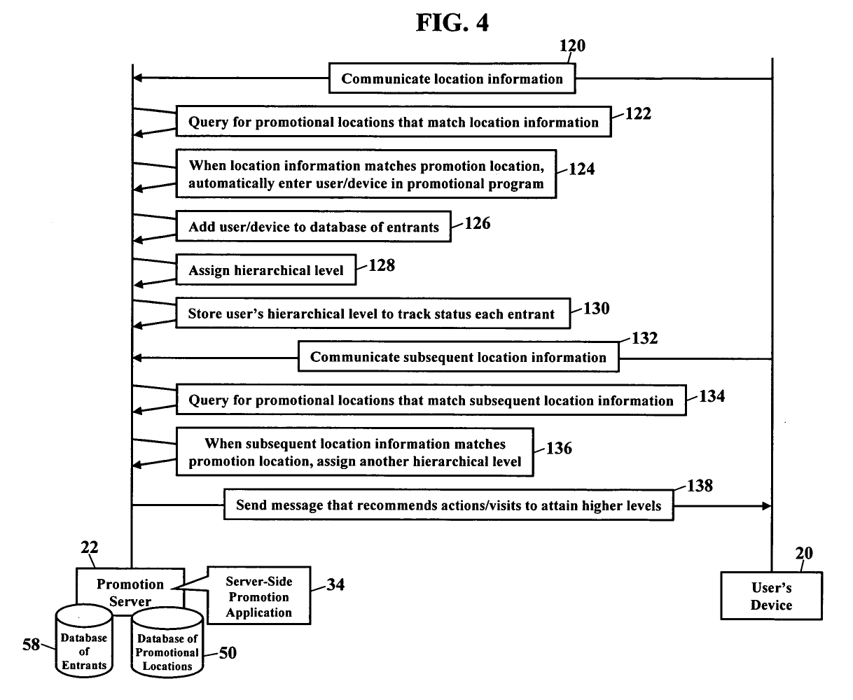

FIG. 4 is a schematic illustrating another process for promotional programs, according to more exemplary embodiments. Here, the user's location qualifies for automatic entry in a multi-level or hierarchical promotional program. That is, whatever the game, drawing, or other promotional program, the user advances to higher levels in the promotional program by making multiple visits to a merchant's (or merchants') physical locations. The user, for example, may be automatically entered in a multi-level promotion, where more or better prizes are progressively offered at higher levels. The user may be required to make multiple visits to a merchant's physical location in order to progress to higher levels of the promotional program. These visits may even be required within a predetermined timeframe. Whatever the promotional program, then, the user's location may qualify for different hierarchical levels.

As FIG. 4 illustrates, the location system 42 communicates the location information to the promotional server 22 (Step 120). When the promotional server 22 receives the location information, the server-side promotion application 34 queries the database 50 of promotional locations (Step 122). When the location information matches a location in the database 50, then the server-side promotion application 34 may automatically enter or enroll the device 20 in the promotional program (Step 124) or provide the user of the device 20 with the option to enter in the promotional program. The server-side promotion application 34 may add the user, and/or an identifier of the user's device 20, to the database 58 of entrants (Step 126). The server-side promotion application 34 may also assign a hierarchical level to the user's device 20 (Step 128). The user's hierarchical level may be stored in the database 58 of entrants, such that the database 58 of entrants tracks the status or level of each entrant (Step 130). As the user continues to carry the device 20, the location system 42 communicates subsequent location information to the promotional server 22 (Step 132). When the promotional server 22 receives the subsequent location information, the server-side promotion application 34 again queries the database 50 of promotional locations (Step 134). When the subsequent location information 44 matches another location in the database 50, then the server-side promotion application 34 may assign another hierarchical level to the device (Step 136). The server-side promotion application 34 may send a message that recommends other actions or visits the user can make to attain higher levels (and potentially win more/better prizes) (Step 138). The message may cause a visual and/or audible confirmation of the user's entry and current level. This confirmation may then be presented to merchants as proof of status. Different hierarchy levels may correspond to different sets of entrants and/or participants, different prizes, different promotional terms, different activities, and different incentives.

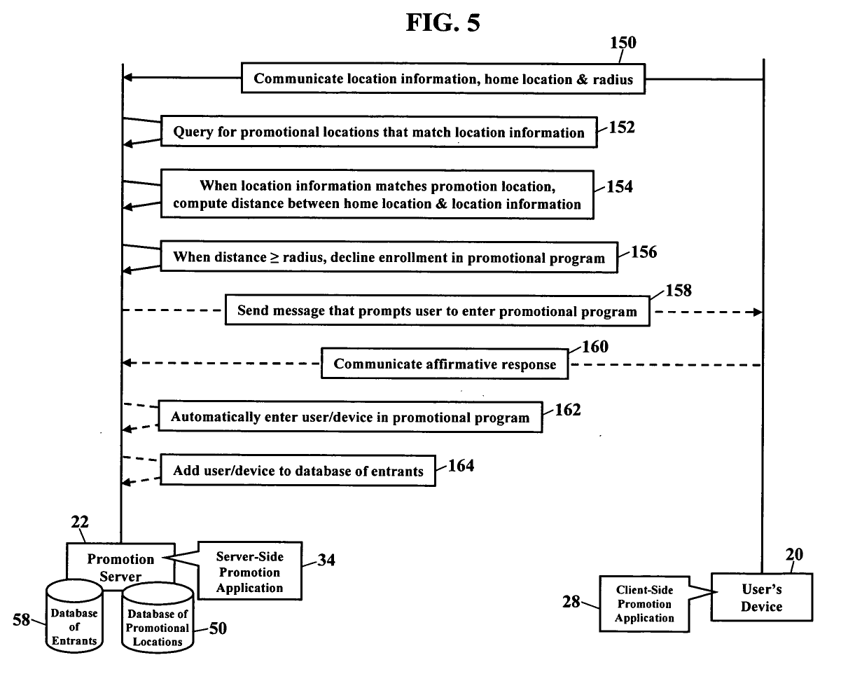

FIG. 5 is a schematic illustrating another process for promotional programs, according to more exemplary embodiments. Here, when the location system 42 communicates the location information to the promotional server 22, the user's device 20 may also retrieve and send a home location and a radius (Step 150). According to exemplary embodiments, the home location is a reference location that the user selects for promotional purposes. The home location and radius may be stored in the memory (shown as reference numeral 30 in FIG. 1) of the user's device 20, but the home location may alternatively be remotely stored and retrieved via the communications network 24. The user may not wish to be automatically enrolled in promotional programs that require visits to distant merchant locations. The user, instead, may only wish to be enrolled in promotional programs that are in the vicinity of the user's home location. The home location, then, may be used to select or filter promotional programs and locations that lie beyond the radius of the user's home location. The user may even establish multiple home or reference locations, such as different reference locations for business-related promotions than for non-business locations, or a user who travels regularly may select reference locations in multiple cities.

The promotional server 22 receives the home location and the radius. The server-side promotion application 34 queries the database 50 of promotional locations to determine if the location information matches a location in the database 50 (Step 152). When the location information matches a promotional location, the server-side promotion application 34 may then compute a distance between the home location and the current location information (Step 154). When the distance between the home location and the current location information is greater than the radius, then the server-side promotion application 34 may decline to enroll the user in the promotional program (Step 156). Alternatively, the server-side promotion application 34 may send a message that prompts the user to enter the promotional program (Step 158). When the client-side promotion application 28 sends an affirmative response (Step 160), then the server-side promotion application 34 may automatically enroll (Step 162) the user, and/or the user's device 20, in the database 58 of entrants (Step 164). Here, then, the user may “opt in” to the promotional program, even though the user may have to travel greater distances to win prizes.

The server-side promotion application 34 may utilize any method or means for computing distance. The home location, for example, may be represented by the coordinates (x_{H}, y_{H}, z_{H}). The current location of the user's device 20 may be represented by the coordinates (x_{D}, y_{D}, z_{D}). The coordinates may be grid coordinates. The coordinates may be latitude, longitude, and elevation (such as altitude or azimuth). The coordinates may be expressed in any x, y, and z coordinate value. These coordinates may be expressed in U.S. Customary and British Imperial units, such as feet and miles, or in metric units, such as meters and kilometers. The coordinates could also be expressed as position, velocity, and time coordinates. However the coordinates are expressed, the server-side promotion application 34 computes a distance r between the corresponding coordinates. Although many methods may be used to compute the distance r, the distance r may be simply computed using

r=\sqrt{Δx²+Δy²+Δz²}.

See FRANCIS W. SEARS ET AL., UNIVERSITY PHYSICS 10-11 (1976). Substituting the respective coordinates, the distance r between the home location and the location of the user's device 20 may be computed using

r=\sqrt{(x_{D}−x_{H})²+(y_{D}−y_{H})²+(z_{D}−z_{H})²}.

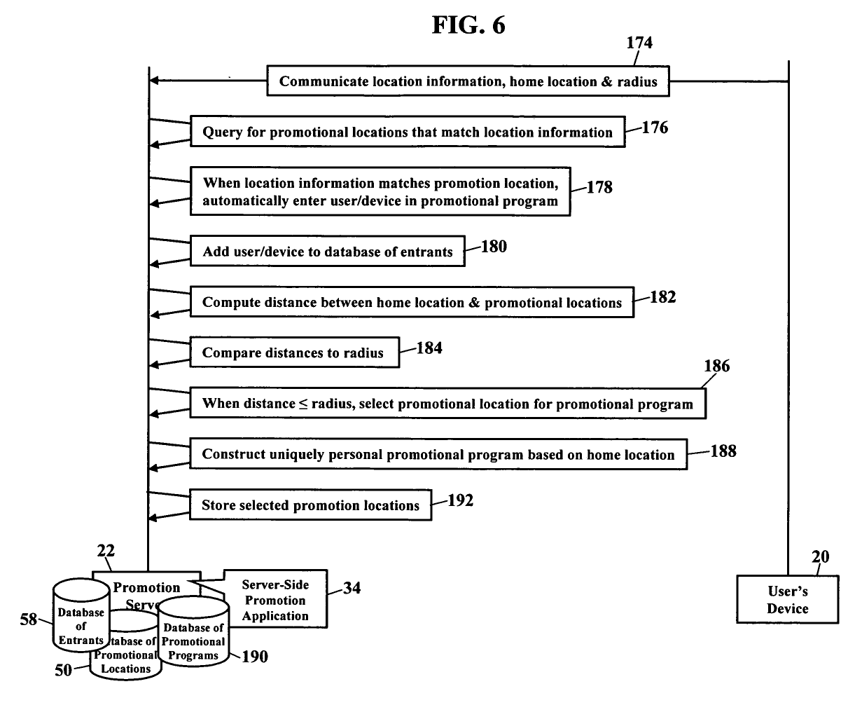

FIG. 6 is a schematic illustrating yet another process for promotional programs, according to more exemplary embodiments. Here promotional programs may be adapted to the user's home location. When a merchant's physical location is too distant from the user's home location, then that merchant's physical location is discarded from the promotional program. As FIG. 6 illustrates, the user's device again communicates the location information, the home location, and the radius to the promotional server 22 (Step 174). The server-side promotion application 34 queries the database 50 of promotional locations to determine if the location information 44 matches a location in the database 50 (Step 176). When the location information matches a location in the database 50, then the server-side promotion application 34 may automatically enter or enroll the device 20 in the promotional program (Step 178) or provide the user of the device 20 with the option to enter or enroll in the promotional program. The server-side promotion application 34 may add the user and/or user's device 20 to the database 58 of entrants (Step 180).

The participating merchants may then be chosen based on distance. Even though the user is automatically enrolled in the promotional program, the server-side promotion application 34 may tailor the promotional program based on the user's home location. Recall that the promotional program offers cash, prizes, or other incentives to entice users to visit participating merchants' retail locations. If the retail locations are too remote from the user's home location, then the user is unlikely to visit. Exemplary embodiments, then, may select the participating merchant's (or merchants') physical locations that are within the vicinity of the user's home location.

As FIG. 6 illustrates, distances are again calculated. When the user is automatically enrolled, the server-side promotion application 34 calculates the distance between the user's home location and each promotional location in the database 50 of promotional locations (Step 182). Each distance is then compared to the radius (Step 184). When the distance between the user's home location and any promotional location (in the database 50 promotional locations) is less than or equal to the radius, then that promotional location is selected for the promotional program (Step 186). That is, the server-side promotion application 34 custom tailors a promotional program for the user. The server-side promotion application 34 selects which merchants participate in the promotional program based on the user's home location. Only merchants in the vicinity of the user's home location participate in the promotion program. Any merchant locations too distant from the user's home location may be excluded from the promotional program. If a merchant's promotional location is excluded, the server-side promotion application 34 may first prompt the user to verify this exclusion. The server-side promotion application 34 may thus build or construct a uniquely personal promotional program, based on the user's home location (Step 188).

The server-side promotion application 34 then stores the selected promotion locations in a database 190 of promotional programs (Step 192). The database 190 of promotional programs maps, relates, or otherwise associates users' home locations to personalized promotional programs. The database 190 of promotional programs is illustrated as being locally stored in the memory 36 of the promotional server 22, yet the database 190 of promotional programs may be remotely accessible via the communications network 24. According to exemplary embodiments, the promotional locations selected for each user's personalized promotional program are stored in the database 190 of promotional programs. As the user's device 20 visits locations in the user's personalized promotional program, the user may advance to higher levels within the promotion (as earlier explained).

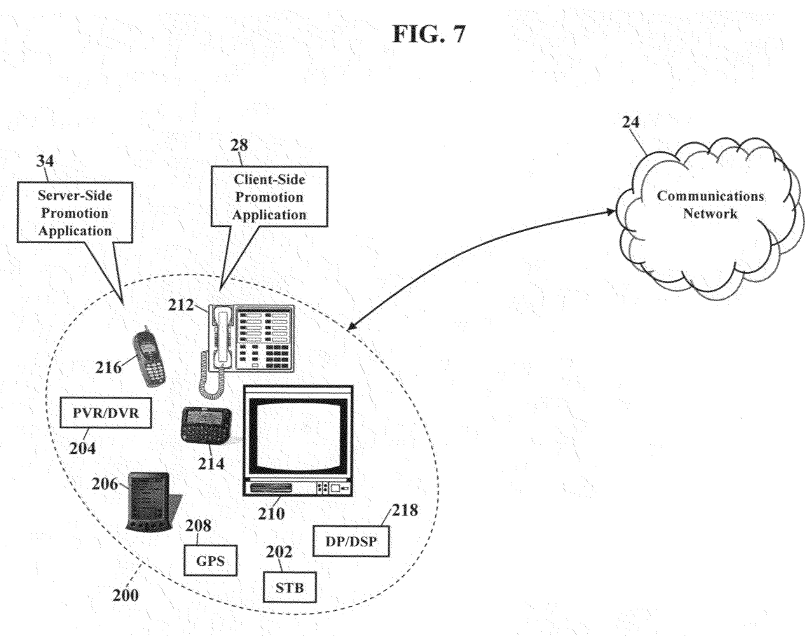

FIG. 7 depicts other possible operating environments for additional aspects of the exemplary embodiments. FIG. 7 illustrates that the client-side promotion application 28 and/or the complementary server-side promotion application 34 may alternatively or additionally operate within various other devices 200. FIG. 7, for example, illustrates that the client-side promotion application 28 and/or the complementary server-side promotion application 34 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital processor and/or a digital signal processor (DP/DSP) 218. The device 200 may also include watches, radios, vehicle electronics, clocks, printers, gateways, mobile/implantable medical devices, and other apparatuses and systems. Because the architecture and operating principles of the various devices 200 are well known, the hardware and software componentry of the various devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V 3.2.0 (1995-01))”; the GSM Standard 11.11, formally known as Specification of the Subscriber Identity Module—Mobile Equipment (Subscriber Identity Module—ME) interface (GSM 11.11 V 5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); EDWARD M. SCHWALB, ITV HANDBOOK: TECHNOLOGIES AND STANDARDS (2004); ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

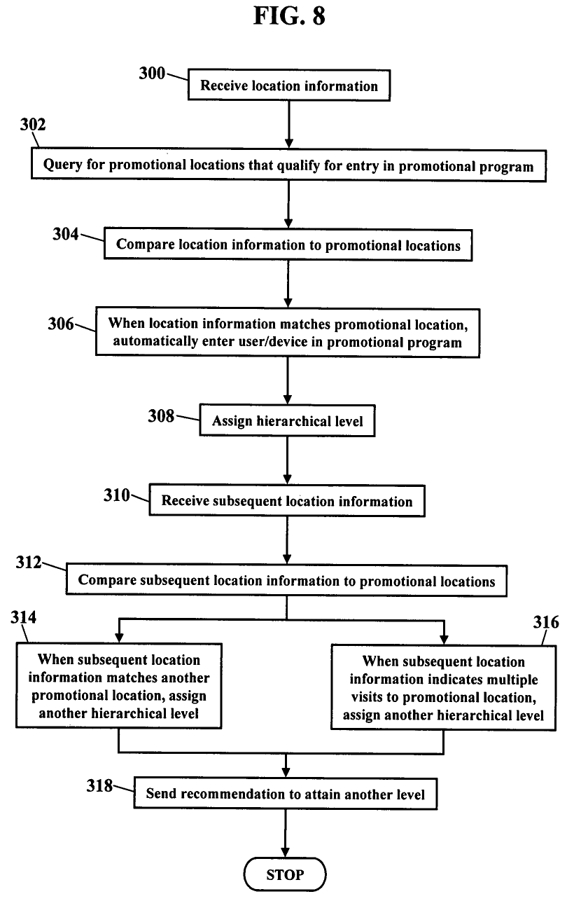

FIG. 8 is a flowchart illustrating a method of promoting a program, according to even more exemplary embodiments. Location information for a device, such as the device 20, is received (Block 300) at the promotional server 22. A query is made by the server-side promotion application 34 for promotional locations that qualify for entry in a promotional program (Block 302). The location information is compared to the promotional locations by the server-side promotion application 34 (Block 304). When the location information matches allocation in the database of promotional locations, then the server-side promotion application 34 may automatically enter the device in the promotional program (Block 306) or provide the user of the device with an option to enter in the promotional program. A hierarchical level is assigned to the device (Block 308) by the server-side promotion application 34. Subsequent location information is received (Block 310) and compared to the promotional locations by the server-side promotion application 34 (Block 312). When the subsequent location information matches another location, then the server-side promotion application 34 may assign another hierarchical level may be assigned to the device (Block 314). When the subsequent location information indicates that the device 20 has visited the location multiple times, then another hierarchical level is assigned to the device by the server-side promotion application 34 (Block 316). The server-side promotion application 34 may send a recommendation is sent that recommends actions to attain another level (Block 318).

Exemplary embodiments may be physically embodied on or in a computer-readable medium. This computer-readable medium may include CD-ROM, DVD, tape, cassette, floppy disk, memory card, flash drive, and large-capacity disk (such as IOMEGA®, ZIP®, JAZZ®, and other large-capacity memory products (IOMEGA®, ZIP®, and JAZZ® are registered trademarks of Iomega Corporation, 1821 W. lomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments. A computer program product comprises processor-executable instructions for promoting programs.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of promoting a program, comprising:
receiving location information for a device;
querying a database of promotional locations for the location information, the database of promotional locations storing locations that qualify for entry in a promotional program; and
when the location information matches a location in the database of promotional locations, then entering the device in the promotional program.

2. A method according to claim 1, further comprising assigning a hierarchical level to the device.

3. A method according to claim 2, wherein when subsequent location information for the device matches another location in the database of promotional locations, then assigning another hierarchical level to the device.

4. A method according to claim 2, wherein when subsequent location information indicates that the device has visited the location multiple times, then assigning another hierarchical level to the device.

5. A method according to claim 2, further comprising sending a recommendation to the device that recommends actions to attain another level.

6. A method according to claim 1, further comprising:
i) querying the database of promotional locations for subsequent location information that describes a subsequent location of the device, and
ii) when the location information and the subsequent location information are matched in the database of promotional locations, only then automatically entering the device in the promotional program.

7. A method according to claim 1, fur ther comprising:
i) querying for a home location associated with the device, and
ii) selecting participating merchants to the promotional program based on the home location, such that only merchants in a vicinity of the home location participate in the promotion program.

8. A system for promoting a program, the system operative to:
receive location information for a device;
query a database of promotional locations for the location information, the database of promotional locations storing locations that qualify for entry in a promotional program; and
when the location information matches a location in the database of promotional locations, then enter the device in the promotional program.

9. A system according to claim 8, further operative to assign a hierarchical level to the device.

10. A system according to claim 9, wherein when subsequent location information for the device matches another location in the database of promotional locations, then the system is operative to assign another hierarchical level to the device.

11. A system according to claim 9, wherein when subsequent location information indicates that the device has visited the location multiple times, then the system is operative to assign another hierarchical level to the device.

12. A system according to claim 9, further operative to send a recommendation to the device that recommends actions to attain another level.

13. A system according to claim 8, further operative to:
i) query the database of promotional locations for subsequent location information that describes a subsequent location of the device, and
ii) when the location information and the subsequent location information are matched in the database of promotional locations, only then automatically enter the device in the promotional program.

14. A system according to claim 8, further operative to:
i) query for a home location associated with the device, and
ii) select participating merchants to the promotional program based on the home location, such that only merchants in a vicinity of the home location participate in the promotional program.

15. A computer program product storing computer-readable instructions for:
receiving location information for a device;
querying a database of promotional locations for the location information, the database of promotional locations storing locations that qualify for entry in a promotional program; and
when the location information matches a location in the database of promotional locations, then entering the device in the promotional program.

16. A computer program product according to claim 15, further comprising instructions for assigning a hierarchical level to the device.

17. A computer program product according to claim 16, further comprising instructions for when subsequent location information for the device matches another location in the database of promotional locations, then assigning another hierarchical level to the device.

18. A computer program product according to claim 16, further comprising instructions for when subsequent location information indicates that the device has visited the location multiple times, then assigning another hierarchical level to the device.

19. A computer program product according to claim 15, further comprising instructions for sending a recommendation to the device that recommends actions to attain another level.

20. A computer program product according to claim 15, further comprising instructions for:
i) querying the database of promotional locations for subsequent location information that describes a subsequent location of the device, and
ii) when the location information and the subsequent location information are matched in the database of promotional locations, only then automatically entering the device in the promotional program.
